(19) United States
(12) Patent Application Publication
(10) Pub. No.: US 2008/0308368 A1
(43) Pub. Date: Dec. 18, 2008

(54) Device for Reducing Vibrations and Sounds

(75) Inventor: Mats Gustavsson, Helsingborg (SE)

Correspondence Address: MICHAUD-DUFFY GROUP LLP, 306 INDUSTRIAL PARK ROAD, SUITE 206, MIDDLETOWN, CT, 06457, US

(73) Assignee: A2 ACOUSTICS AB, Linkoping (SE)

(21) Appl. No.: 11/883,112

(22) PCT Filed: Feb. 2, 2006
(86) PCT No.: PCT/SE06/00153

§ 371 Date: Feb. 25, 2008

(30) Foreign Application Priority Data
Feb. 2, 2005 (SE) 0500245-6
Mar. 3, 2005 (SE) 0500491-6

(51) Int. Cl. F16F 7/10

(52) U.S. Cl. 188/380

(57) ABSTRACT

The invention refers to a device for reducing vibrations and sounds in a structure (1). The device comprises at least a dynamic element (4), which extends along two main axes and has a mass-moment of inertia, and at least a spring element (5) which is connected to the dynamic element (4) and which is adapted to be connected to the structure. The mass-moment of inertia is different with respect to the two main axes. The dynamic element is rotatable around an axis (x) of rotation, which is perpendicular to the two main axes.

### CROSS-REFERENCE TO RELATED APPLICATIONS

This application is entitled to the benefit of and incorporates by reference essential subject matter disclosed in International Application No. PCT/SE2006/000153 filed on Feb. 2, 2006 and Swedish Patent Application No. 0500245-6 filed on Feb. 2, 2005 and Swedish Patent Application No. 0500491-6 filed Mar. 3, 2005.

### FIELD OF THE INVENTION

The present invention refers to a device for reducing vibrations and sounds in a structure according to the preamble of claim 1.

### BACKGROUND OF THE INVENTION

In many various technical applications, such as in aircraft, motor vehicles, ships, various machines and industrial plants, it is desirable to reduce vibrations and sounds. Such vibrations or sounds can have one or several main fundamental frequencies. In aircraft, at least one fixed motor speed, which offers an economically advantageous balance between fuel cost and speed, is frequently utilized. This motor speed results in vibrations and sounds with a relatively well defined fundamental frequency. In order to reduce these vibrations, it is known to mount a large number of vibration absorber elements. The basic principal of these vibration absorber elements is to create a resonant system having a mass and spring connected to the object or the structure from which the vibration energy is to be absorbed. These vibration absorber elements are passive and tuned for an efficient absorption of vibrations and sounds having this defined fundamental frequency. US-A-2004/0134733 discloses such a passive vibration absorber.

In various aircraft contexts, for instance propeller-driven aeroplanes, two or several fixed motor speeds are frequently used during flight for optimising performance, fuel consumption or comfort at various flight states. These various motor speeds result in vibrations and sounds with two or several relatively well defined fundamental frequencies. The known passive vibration absorber elements give a poor effect when several motor speeds are used since they merely operate against one frequency.

In order to solve this problem, it is known to use, for instance, two different vibration absorber elements, which are tuned to a respective defined frequency. However, this increases the required quantity of absorber elements in an undesired manner. Furthermore, the absorber elements which do not respond to the actual frequency may instead result in an amplification of vibrations and sounds. Furthermore, it has been proposed to use instead adjustable absorber elements, i.e. vibration absorber elements which are adjustable to operate against several different frequencies. The known adjustable absorber elements require some kind of electric motor or any similar adjustment member for providing the desired adjustment. Furthermore, extensive wiring for current supply, and control equipment for the adjustment of the absorber elements are required. One example of such an adjustable absorber element is disclosed in U.S. Pat. No. 5,954,169. More specifically, this document discloses a vibration absorber having a tuned mass which by means of a motor is displaceably provided in relation to a flexible plate. Other examples of adjustable absorber elements are disclosed in EP-A-922 877 and U.S. Pat. No. 3,487,888. The Swedish patent application 0500245-6 discloses a similar device.

### SUMMARY OF THE INVENTION

The object of the invention is to provide a simple vibration absorber which is arranged to operate against different frequencies.

This object is achieved by the device initially defined, which is characterized in that the dynamic has differing mass-moment of inertia with respect to the two main axes, and that the dynamic element is rotatable in relation to the structure around an axis of rotation, which is perpendicular to the two main axes.

By means of such a device a resonant vibration absorber is achieved, which thanks to the rotatable dynamic element is adaptive. The dynamic element will adjust itself into such a rotary position that a maximum vibration amplitude is achieved for the swinging mass of the dynamic element at vibration excitation at, or in the proximity of, one of the resonance frequencies of the device. By means of the invention, a simple device is thus achieved, which without any actuating member can absorb two or several different vibration frequencies.

According to an embodiment of the invention, the spring element with a part thereof is fixedly mounted in relation to the structure.

According to a further embodiment of the invention, the two main axes are orthogonal with respect to the mass-moment of inertia.

According to a further embodiment of the invention, the device comprises a primary connection element, which extends in parallel to the axis of rotation. The dynamic element may then be rotatably journalled on the primary connection element and may have a differing geometrical design along the two main axes.

According to a further embodiment of the invention, the device comprises two such dynamic elements, which are connected to a respective end of the primary connection element.

According to a further embodiment of the invention, the primary element forms the spring element or alternatively two spring elements. In the latter case, the primary connection element may with a central part thereof be fixedly mounted in relation to the structure.

According to a further embodiment of the invention, the device comprises at least a further dynamic element, which is rotatably connected to a secondary connection element. Advantageously, the secondary connection element is rotatably connected to an outer end of the primary connection element. Furthermore, the device may comprise at least two further dynamic elements, which are rotatably connected to a respective secondary connection element, which in turn can be rotatably connected to a respective outer end of the primary connection element. Said further dynamic elements are advantageously rotatably journalled at a respective outer end of said secondary connection elements. Also said secondary connection elements may form spring elements.

According to a further embodiment, the device comprises a further spring element, which connects the primary connection element to the structure. The spring element may be designed to permit an energy-absorbing spring movement including bending, a longitudinal deformation and/or shearing of the spring element.

### BRIEF DESCRIPTION OF THE DRAWINGS

The present invention is now to be explained more closely by means of a description of various embodiments and with reference to the drawings attached hereto.

FIG. 1 discloses a sideview of a first embodiment of a device according to the invention.

FIG. 2 discloses a cross-section through a dynamic element of the device along the line II-II in FIG. 1.

FIG. 3 discloses a sideview of a second embodiment of a device according to the invention.

FIG. 4 discloses a cross-section through a spring element having an alternative design.

FIG. 5 discloses a sideview of a fifth embodiment of a device according to the invention.

### DETAILED DESCRIPTION OF VARIOUS EMBODIMENTS OF THE INVENTION

FIG. 1 discloses a first embodiment of a device according to the invention for reducing vibrations and sounds in a structure. This structure may be a vehicle, for instance an aircraft or a ship, or any other stationary structure, for instance a building, a machine tool or any structure where it is desirable to reduce vibrations.

The device according to the first embodiment comprises a primary connection element 2. The primary connection element 2 is in the first embodiment designed as an elongated rod which extends in a longitudinal direction. The primary connection element 2 is with a part thereof fixedly mounted in relation to the structure 1 via an attachment 3. In the first embodiment, the primary connection element 2 is with an end part fixedly connected to the attachment 3 and the structure 1.

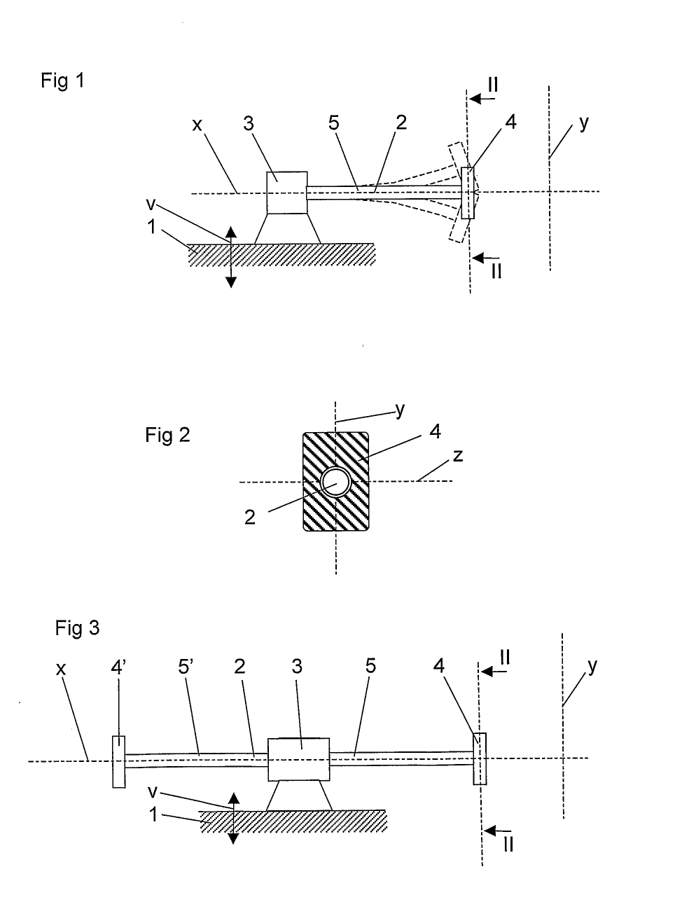

The device also comprises a dynamic element 4, which has a determined mass-moment of inertia. The dynamic element 4 gives rise to forces of inertia when it is accelerated in a translation movement and a rotation movement. Forces of inertia are related to the mass and the mass-moment of inertia of the dynamic element. The dynamic element 4 extends along two main axes y and z, see FIG. 2. The mass-moment of inertia is different with respect to the two main axes y and z, and more specifically the two main axes are orthogonal with respect to the mass-moment of inertia. The dynamic element 4 has a differing geometrical design, a differing mass distribution or a combination of these properties along the two main axes y and z. In the first embodiment, this is exemplified through a differing geometrical design with different dimensions of the dynamic element along the two main axes y and z, and more specifically, by the fact that the cross-section of the dynamic element 4 is wider along the main axis y than along the main axis z.

The dynamic element 4 is rotatable around an axis x of rotation, which substantially coincides with the longitudinal direction of the primary connection element 2 and which is perpendicular to the two main axes y and z. The dynamic element 4 may be rotatably journalled directly on the primary connection element 2. The dynamic element 4 may also be rotatably journalled on the primary connection element 2 by means of a rotary bearing, for instance in the form of a slide bearing or a roller bearing.

The primary connection element 2 forms a spring element 5 which is designed to permit an energy-absorbing spring movement through bending of the spring element 5, as is indicated in FIG. 1 with dashed lines, when the structure 1 vibrates in the vibration direction v.

The device according to the first embodiment is adapted to absorb two different vibration frequencies through the rotation of the dynamic element 4 to an optimum position in relation to the primary connection element 2 with respect to the frequency with which the structure 1 vibrates.

FIG. 3 discloses a second embodiment of the invention. It is here to be noted that elements having substantially the same function have been provided with the same reference signs in all described embodiments. The device according to the second embodiment differs from the device according to the first embodiment in that it comprises two such dynamic elements 4, 4′, which are connected to a respective end of the primary connection element 2. The two dynamic elements 4, 4′ may be substantially equal to each other and to the dynamic element 4 in the first embodiment. In the second embodiment, the primary connection element 2 is with a central part thereof fixedly mounted in the attachment 3. The primary connection element 2 thus forms two spring elements 5, 5′ having a respective dynamic element 4, 4′. The two spring elements 5, 5′ and the two dynamic elements 4, 4′ are substantially symmetrically designed and positioned with respect to the central attachment 3.

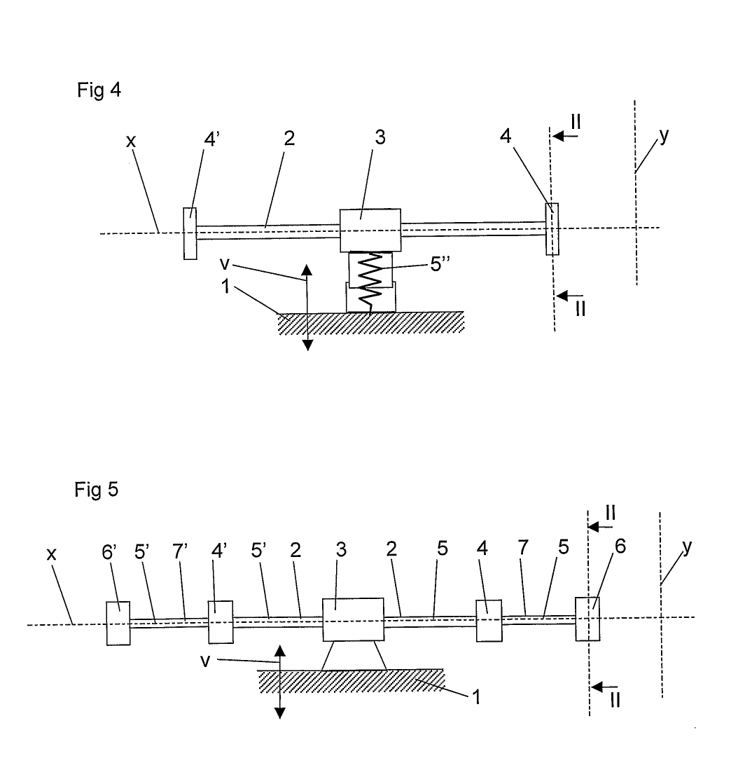

FIG. 4 discloses a third embodiment, which differs from the second embodiment in that a further spring element 5″ is arranged between the attachment 3 and the structure 1. The combination of two spring elements 5, 5′, 5″ may then advantageously be used for improving the dynamic properties, such as fatigue strength and adaptation of the dissipation factor, of the vibration absorber.

FIG. 5 discloses a fifth embodiment of the invention, which differs from the remaining embodiments, especially the third embodiment, in that the device comprises two further dynamic elements 6, 6′, which by means of a respective secondary connection element 7, 7′ are connected to a respective outer end of the primary connection element 2. The two further dynamic elements 6, 6′ are rotatable in relation to the respective secondary connection element 7, 7′ in the same way as the dynamic elements 4, 4′ are rotatable in relation to the primary connection element 2 in the fifth embodiment and the remaining embodiments. The secondary connection elements 7, 7′ are furthermore advantageously rotatably connected to the primary connection elements 2, for instance by means of a suitable rotary bearing.

The two secondary connection elements 7, 7′ are also designed as a respective elongated rod, which extends along the axis x of rotation and forms a respective spring element 5, 5′. These further spring elements 5, 5′ permit an energy-absorbing spring movement through bending of the respective spring element 5, 5′.

The spring element 5, 5′ and the dynamic element 4, 4′ of the primary connection element 3 then form a first dynamic unit, whereas the spring element 5, 5′ and the further dynamic elements 6, 6′ of the secondary connection elements 7, 7′ form a second dynamic unit. According to the fifth embodiment, a device is achieved, which can be adapted to 2², i.e. 4 different frequencies. It is to be noted that in principal it is possible to provide further dynamic elements which are rotatably connected to the outer ends of the secondary connection elements 7, 7′. In such away the number of dynamic units may be further increased, wherein the device can be adapted to 2^{N} different frequencies, where N is the number of dynamic units.

The device according to the invention will thus by itself provide a rotation of the dynamic elements 4, 4′ around the axis x of rotation to an optimum position for different operation states. This adaptation takes place spontaneously without any particular, forced rotation of the dynamic elements 4, 4′, thanks to the fact that the dynamic elements 4, 4′ strive to reach resonance. According to a variant of the invention, some kind of actuating members may be provided for providing the desired rotation.

In this description, merely the fundamental frequency of the spring elements 5, 5′ with the associated dynamic elements 4, 4′ has been considered, i.e. a spring movement where all spring elements 5, 5′ all dynamic elements 4, 4′ and possible rotary bearings 7, 7′ are moving in phase. Furthermore, it is assumed that the device according to FIGS. 3-5 are symmetrical with respect to the attachment 3. In a more advanced description of the function of the device, a plurality of fundamental frequencies and associated natural oscillation forms will be identified. Certain of these may be undesired and their negative influence may be limited or eliminated through a change of the geometry and/or the choice of material. Other resonances in addition to the fundamental resonance may be used for instance for simultaneous reduction of a fundamental tune and overtunes to a vibration.

The invention is not limited to the embodiments disclosed but may be varied and modified within the scope of the following claims. The embodiments disclosed may be combined with the embodiments and properties disclosed in the Swedish application 0500245-6.

1-21. (canceled)

22. A device for reducing vibrations and sounds in a structure, comprising at least one dynamic element, which extends along two main axes,
at least one spring element, which is connected to the dynamic element and which is adapted to be connected to the structure,
the dynamic element having a differing mass-moment of inertia with respect to the two main axes, and
that the dynamic element is rotatable in relation to the structure around an axis of rotation, which is perpendicular to the two main axes.

23. A device according to claim 22, wherein the spring element is fixedly mounted in relation to the structure.

24. A device according to claim 22, wherein the two main axes are substantially orthogonal with respect to the mass-moment of inertia.

25. A device according to claim 22, further comprising a primary connection element which extends substantially parallel to the axis of rotation.

26. A device according to claim 25, wherein the dynamic element is rotatably journalled on the primary connection element.

27. A device according to claim 26, wherein the dynamic element has a different geometrical design along the two main axes.

28. A device according to claim 26, wherein the dynamic element has a differing mass distribution along the two main axes.

29. A device according to claim 27, wherein the dynamic element has a differing mass distribution along the two main axes.

30. A device according to claim 25, further comprising two dynamic elements which are connected to a respective end of the primary connection element.

31. A device according to claim 25, wherein the primary connection element forms the spring element.

32. A device according to claim 30, wherein the primary connection element forms two spring elements.

33. A device according to claim 30, wherein the primary connection element with a central part thereof is fixedly mounted in relation to the structure.

34. A device according to claim 31, wherein the primary connection element with a central part thereof is fixedly mounted in relation to the structure.

35. A device according to claim 25, further comprising at least a further dynamic element, which is rotatably connected to a secondary connection element.

36. A device according to claim 35, wherein the secondary connection element is rotatably connected to an outer end of the primary connection element.

37. A device according to claim 35, wherein the device comprises at least two further dynamic elements, which are rotatably connected to a respective secondary connection element.

38. A device according to claim 36, wherein the device comprises at least two further dynamic elements, which are rotatably connected to a respective secondary connection element.

39. A device according to claim 37, wherein the secondary connection elements are rotatably connected to a respective outer end of the primary connection element.

40. A device according to claim 35, wherein said further dynamic elements are rotatably journalled at a respective outer end of said secondary connection elements.

41. A device according to claim 35, wherein said secondary connection elements form the spring element.

42. A device according to claim 25, wherein the device comprises a further spring element, which connects the primary connection element to the structure.

43. A device according to claim 22, wherein the spring element is designed to permit an energy-absorbing spring movement which includes bending of the spring element.

44. A device according to claim 22, wherein the spring element is designed to permit an energy-absorbing spring movement, which includes a longitudinal deformation of the spring element.

45. A device according to claim 22, wherein the spring element is designed to permit an energy-absorbing spring movement, which includes shearing of the spring element.
